(19) United States
(12) Patent Application Publication
(10) Pub. No.: US 2026/0254559 A1
(43) Pub. Date: Aug. 27, 2026

(54) METHOD FOR DESCRAMBLING AND SYMBOL DECODING

(71) Applicant: Tektronix, Inc., Beaverton, OR (US)

(72) Inventor: P. E. Ramesh, Bangalore (IN)

(21) Appl. No.: 19/546,222

(22) Filed: Feb. 20, 2026

(30) Foreign Application Priority Data
Feb. 21, 2025 (IN) 202521015123

(51) Int. Cl. H04L 1/00

(52) U.S. Cl. CPC H04L 1/005

(57) ABSTRACT

A test and measurement device including a first input structured to acquire data from a sideband data communication channel that carries data related to one or more high speed data channels between a host and a device, a second input structured to acquire data signals carried on the related high speed data channel, and one or more processors structured to send a command to provoke the host to send a retiming message that includes one or more scrambling codes that were used to encode data signals on the coupled high speed data channel, extract the one or more scrambling codes from the retiming message, convert the data signals received on the coupled high speed data channel to coded data, descramble the coded data using the one or more scrambling codes extracted from the retiming message, and search the descrambled data for a predetermined code sequence. Methods are also described.

### CROSS-REFERENCE TO RELATED APPLICATIONS

This disclosure claims priority under 35 U.S.C. § 119 to Indian Provisional Patent Application No. 202521015123, titled “METHOD FOR DESCRAMBLING AND SYMBOL DECODING OF THE USB4V2 INTERFACE USING USB4 DATA BUS SIGNAL,” filed on Feb. 21, 2025, the disclosure of which is incorporated herein by reference in its entirety.

### TECHNICAL FIELD

The present disclosure relates to a method for descrambling and symbol decoding when monitoring an information data stream.

### BACKGROUND

Universal Serial Bus v4 2.0 (USB4 v 2.0) Standard is a set of data transmission standards between devices that doubles the maximum data transfer rate from approximately 40 Gbps in USBV4to approximately 80 Gbps in USB4 v2.0). The USB4 v 2.0 Standard uses a new physical layer (PHY) architecture based on Pulse-Amplitude Modulation-3 Level (PAM-3) signal encoding, which allows it to achieve these high speeds over existing Type-C cables. The USB4 v2.0 Standard is published by the USB Implementers Forum, which is incorporated herein by reference.

Generally, information about the data channel is shared between a transmitter and receiver when establishing a data communication path. This initialization process is referred to as link training, where information such as scrambling codes, timing information (such as the start of Forward Error Correction (FEC) blocks), and other information are shared between a USB4 v2.0 host and a device/hub in data communication with the host using that data transmission standard.

Sometimes, test and measurement systems wish to monitor the data channel for testing purposes. Although such systems can readily detect the PAM-3 signals, they cannot decode the data sent between the host and downstream device from the PAM-3 signals because they lack the information, such as scrambling codes and timing data, that were shared only between the host and the device/hub during link training.

### BRIEF DESCRIPTION OF ACCOMPANYING DRAWINGS

FIG. 1 illustrates a test and measurement device, such an oscilloscope, including a data decoder for decoding and symbol decoding of a data stream according to embodiments of the disclosure.

FIG. 2 is a diagram of a USBV4 V2.0 host coupled to a USB4 V2.0 device in a conventional data communication connection.

FIG. 3A is a conventional flowchart of operations of a USB4 V2.0transmitter preparing data to be sent from the transmitter.

FIG. 3B is a conventional flowchart of operations of a USB4 V2.0 receiver accepting and decoding data, which is the inverse of the operations of FIG. 3A.

FIG. 4 illustrates a defined Time Sync Notification Ordered Set according to the USB4 V2.0 Standard.

FIG. 5 illustrates a defined, 7trit, control symbol used as part of the Time Sync Notification Ordered Set of FIG. 4, according to the USB4 V2.0 Standard.

FIG. 6 illustrates the scrambling F stream generation according to the USB4 V2.0 Standard.

FIG. 7 is a flowchart illustrating example operations to perform descrambling and decoding data acquired from a data stream according to embodiments of the disclosure.

FIG. 8 is an example sequence of ternary data created from binary data and acquired scrambling codes according to embodiments of the disclosure.

FIG. 9 is a conventional method of inserting pre-codes into a ternary data stream.

FIG. 10 illustrates an FEC block according to the USB4 v2.0 standard.

FIG. 11 illustrates predetermined codes inserted into a data stream according to the USB4 v2.0 standard.

### DETAILED DESCRIPTION

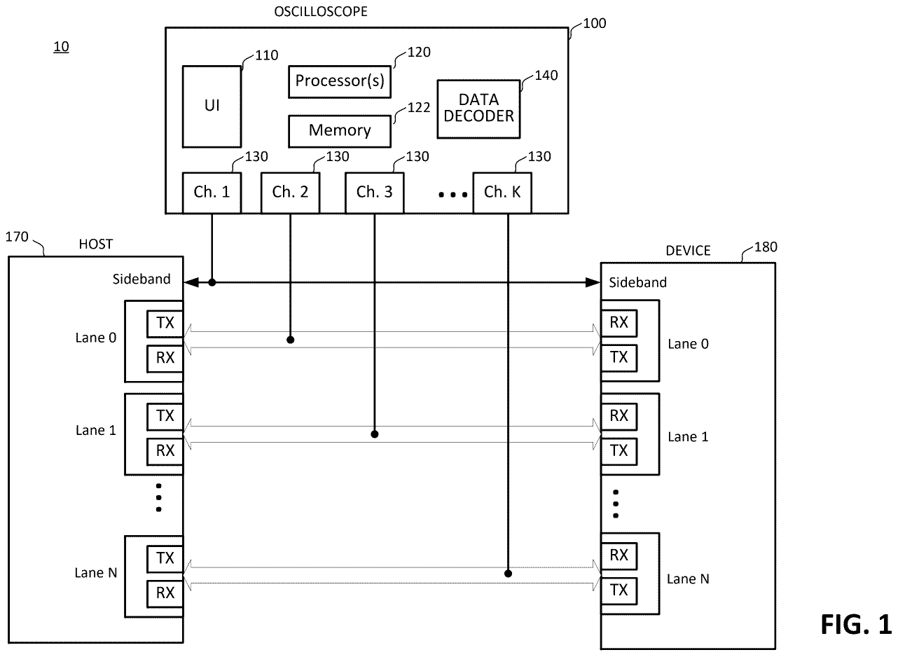

FIG. 1 illustrates a testing system 10, including a test and measurement device, such as an oscilloscope 100, structured to monitor a sideband as well as one or more bi-directional data lanes coupled between a host 170 and device 180. In some embodiments the host 170 and device 180 communicate using the USB4 V2.0 data transmission standard referenced above.

The oscilloscope includes a user interface 110, through which a user can set up and perform tests and measurements based on signals acquired by the oscilloscope 100. One or more processors 120 and associated memory 122 are used to store and perform operations used to control the oscilloscope 100.

Signals are acquired by the oscilloscope 100 through signal channels 130, each of which may be coupled to a particular communication channel, or lane, established between the host 170 and device 180.

The oscilloscope 100 also includes a data decoder 140, described in detail below, that allows the oscilloscope 100 to descramble and decode data sent between the host 170 and device 180 even though the oscilloscope did not receive data link information as the communication lanes between the host 170 and device 180 were established.

When the oscilloscope 100 acquires the data signals from the data lanes 0, 1, 2, etc. between the host 170 and device 180, it is generally without knowledge of the starting of the frame end of the frame, scrambling initialization etc. that were established between the host 170 and device 180 during link training. Instead, the oscilloscope is only able to receive the raw PAM-3 signals sent between the host 170 and device 180 as part of the transactions. Unlike binary signaling, which has two signal levels such as 0 and 1, PAM-3 signals use ternary symbols to represent three separate values. Sometimes the signal levels may be referred to as −1, 0, and +1. The PAM-3 symbols are referred to as trits, and are typically represented as 0, 1, and 2.

One challenge when attempting to decode information sent between the host 170 and device 180 is that there are two unknowns that are very essential for decoding the received PAM-3 signals. One unknown is the start of the FEC frame, so that it can be decoded. But the trits in USB4 v2.0 are scrambled in trits space and not in binary space, so the user does not know the scrambling sequence value either at the beginning of the waveform or any part of the waveform in order to lock onto the start of FEC packet in the incoming signal.

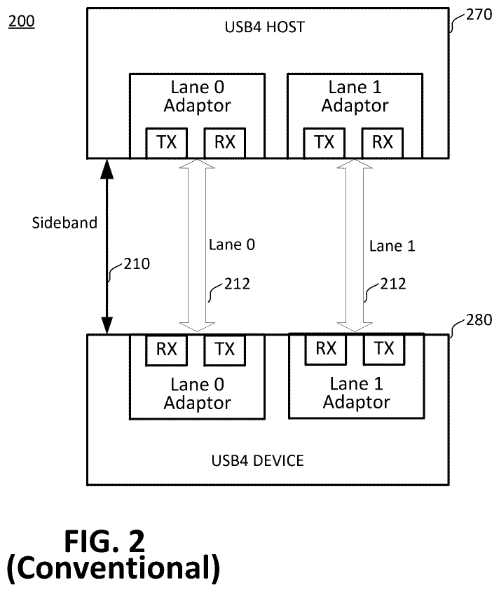

FIG. 2 is a diagram of a communication system 200 with a USBV4 V2.0 host 270 coupled to a USB4 V2.0 device 280 in a conventional data communication connection.

According to the USB4 V2.0 Standard, a sideband channel 210 used for initiating connection and configuring the link between the host 270 and a device 280 during the link setup, or link training. The link between the host 270 and a device 280 can be operated in symmetric mode where Transmit (TX) and Receive (RX) are interconnected, as illustrated in FIG. 2, or in an asymmetric mode (not illustrated), where data can be transmitted on a single lane and the remaining 3 lanes can receive. The sideband channel 210 carries binary signals, while the USB Lanes 212 carry ternary signals, encoded with PAM-3 encoding. Typically, there are 4 lanes in a standard USB communication system, and one sideband.

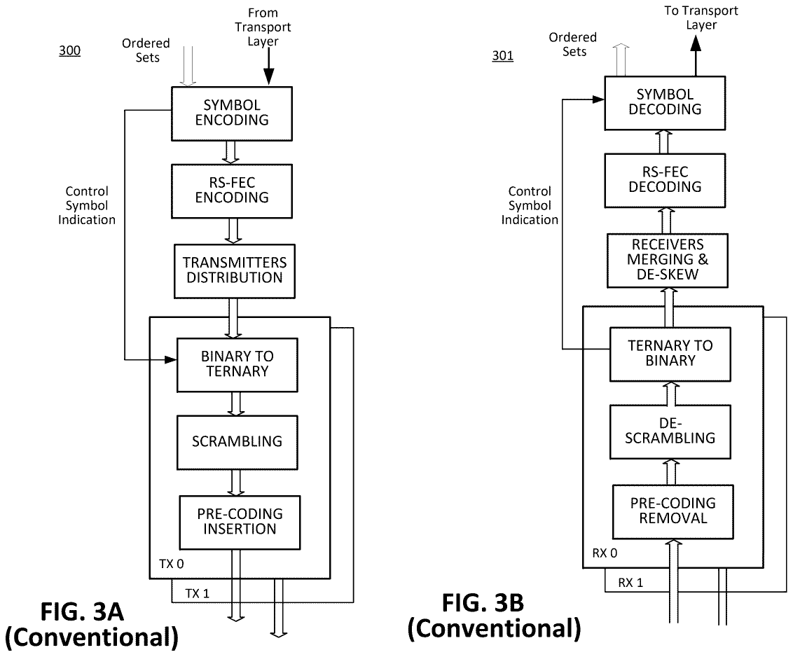

FIG. 3A is a conventional flowchart 300 of operations of a USB4 V2.0transmitter preparing data to be sent from the transmitter. FIG. 3B is a conventional flowchart of operations 301 of a USB4 V2.0 receiver accepting and decoding data, which is the inverse of the operations of FIG. 3A.

The data of USB4 V2.0 ordered sets are inserted into the data flow between the host and device of a USB system to be used for logical layer control purposes. Briefly, data from a transport layer is divided as 11 bits symbols and the symbols are packetized. Then Read Solomon encoding is done and added to the FEC code. If there are multiple transmitters, as illustrated in FIG. 3A, which illustrates two transmitters, then each RS-FEC block is distributed among the transmitters. The incoming binary symbol on each transmitter is converted to ternary symbols (trits) and then the trits are scrambled using two or more scrambling codes, each of which are unique to each transmitter, as described in detail below. After pre-coding insertion is performed, the data is then transmitted from each transmitter as PAM-3 signal trits. Both the ordered set and data from the transport layer goes through these blocks. Whenever the ordered set is transmitted, it is simultaneously transmitted on all the lanes of the USB system by the transmitters.

The reverse operation of the transmitter is performed in the receiver flowchart 300 as shown in FIG. 3B. The ordered sets can be inserted in transport layer packet as well, but it shall be transmitted as the first symbol in the RS-FEC block with four ordered set value repeated as control symbol, each symbol is of length 7 trits.

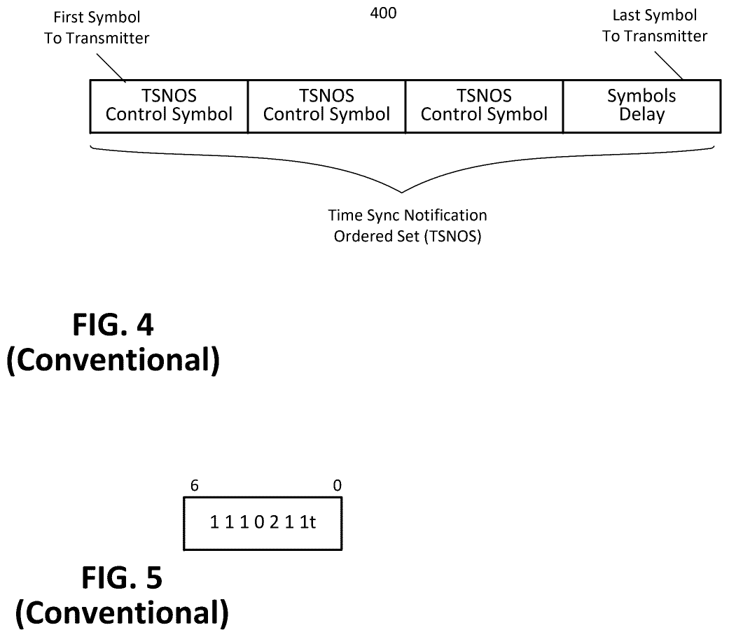

The transmitter and receiver within the data lanes are periodically synchronized using a Time Sync Notification Ordered Set (TSNOS) 400, which consists of three TSNOS control symbols, in succession, followed by “symbol delay” data symbols as shown in FIG. 4. The TSNOS control symbol is defined in the USB4 V2.0 Standard as “1110211t”, as illustrated in FIG. 5. The “t” describes that the control symbol is provided in trit space, i.e., according to the symbol coding produced by PAM-3. Thus, to make the TSNOS of FIG. 4, the particular TSNOS control symbol of FIG. 5 is repeated three times, followed by the symbols delay. As described in more detail below, embodiments of the disclosure make use of the TSNOS control symbol as part of the decoding and descrambling performed by the oscilloscope 100 (FIG. 1) according to embodiments of the disclosure.

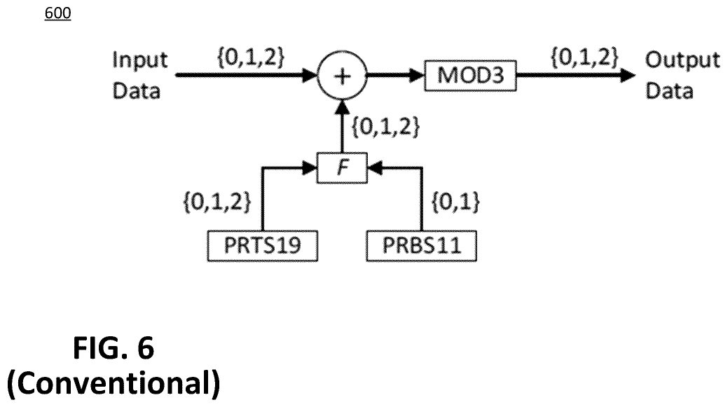

FIG. 6 illustrates a defined method 600 of scrambling performed by each transmitter, which is one of the operations of the flowchart 300 illustrated in FIG. 3A. With reference to FIG. 3A, each transmitter converts the binary stream to a ternary one, i.e., a stream of trits. Then each trit is sent to the scrambler in the order it is transmitted on the wire—Most Significant Trit (MST) to Least Significant Trit (LST). As illustrated in FIG. 6, in the USB4 v2.0 Standard, scrambling is performed by adding, (modulo 3), a pseudo-random ternary sequence to the output of the binary-to-ternary conversion described above. The pseudo-random sequence is generated by applying a function F to an output of a ternary Linear-Feedback Shift Register (LFSR) having 19taps (referred to as PRTS19) and a binary LFSR having 11 taps (referred to as PRBS11). The F operation in the ternary finite field keeps the PRTS19 ternary symbol unchanged if the corresponding PRBS11 bit is equal to 1b, and switches a ternary value of 2t with a ternary value of 0t, and vice-versa, if the corresponding PRBS11 bit is 0b.

Knowing the PRTS19 and PRBS11 values used to scramble each lane is necessary to be able to correctly descramble the PAM-3 codes later detected by the oscilloscope 100 (FIG. 1). According to the USB4 V2.0 Specification, the particular initialization values for PRTS19 and PRBS11 are based on the number of active transmitters on the USB link.

One of the debugging features available in USB4 V2.0 is a Scrambler Re-Synchronization Feature. The Scrambler Re-Synchronization Debug feature allows test devices to associate sampled high-speed data to their scrambler LFSR values, specifically the LFSR values for PRTS19 and PRBS11, by receiving the Re-Synchronization Point information over the sideband channel of the USB link.

This is accomplished by having a Port to send 21trits at Gen 4 speed for each Lane in the USB system, providing a unique identification of the correct LFSR position at high probability. Once the Re-Synchronization location is identified by the test device, it can perform de-scrambling of the captured data as well as Lane-alignment between the active transmitters.

At least one method of acquiring the present values of PRTS19 and PRBS11 for each transmitter channel is performed by first sending the Scrambler Re-Synchronization command, or request, over the sideband. For example, with reference to FIG. 1, the oscilloscope 100 can use the debug command set to cause the host 170 to send a Scrambler ReSynch Message back on the sideband, which is received by the oscilloscope 100. As described below, the present values of PRTS19 and PRBS11, which are necessary to be able to descramble trits later acquired by the oscilloscope 100, for each transmitter channel, are contained in certain locations of the Scrambler ReSynch Message. Further, Scrambler Re-Synchronization command allows test devices, such as the oscilloscope 100 (FIG. 1) to associate sampled high-speed data with their scrambler LFSR values by receiving their correct Re-Synchronization Point. Initiating the Scrambler Re-Synchronization command also provides the LFSR of the respective transmitters in the lanes of the USB system, which allows the oscilloscope 100 to align the sideband of the USB system, which operates at a relatively slow 1 Mbps, to the data lanes of the USB system, which, for USB4 v2.0, can operate up to 80 GBps.

However, even though the high-speed signal is acquired by the oscilloscope 100 (FIG. 1), the challenge is that the scrambler current value F output and the start of the FEC block in the incoming trits data stream is still not known. As described above, the present values of PRTS19 and PRBS11 for each transmitter channel need to be known, and, even if they are known, such as by executing the Scrambler Re-Synchronization command, there is no defined way to locate the start and end of the FEC block merely by examining the PAM-3 signals carried on the data lanes of the USB system. Embodiments of the disclosure allow the start and end of the FEC block to be determined, as described in more detail below.

Thus, there is a need to find the value of F such that the incoming trits can be decoded and also identify the start of the FEC block after converting Trits to binary values.

In one aspect of the invention, methods and systems of the present disclosure find the value of F such that the incoming trits can be decoded, and also identify the start of the FEC block after converting Trits to binary values.

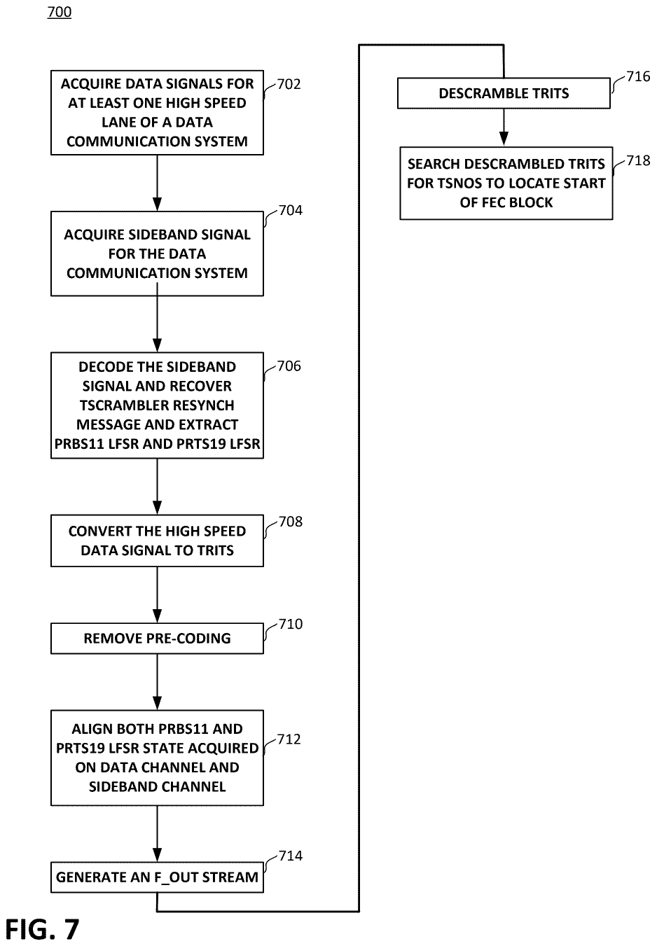

FIG. 7 is a flowchart 700 including example operations, typically performed by a computer processor, such as the one or more processors 120 of the oscilloscope 100 of FIG. 1, for determining F Streams and the start of the FEC stream. In other embodiments, the data decoder 140 of the oscilloscope 100, which may include its own processor and memory, not illustrated, may perform the below operations, either by itself or in conjunction with the one or more processors 120.

The flowchart 700 begins at an operation 702 where data signals for at least one high-speed lane of a data communication system are acquired. For example, the data communication system may be a USB system, such as USB4 v2.0, or could be another system. As described above, for a USB4 v2.0, the data signals are encoded using PAM-3 encoding. Signals may be acquired using one or more of the data channels 130 of the oscilloscope 100 illustrated in FIG. 1.

Next, in an operation 704, the sideband signal for the data communication system is also acquired. In the described embodiment, another of the data channels 130 of the oscilloscope 100 is used to acquire the sideband signal. Actions performed in this operation may include using a debug command to provoke the host to send a Scrambler ReSynch Message, and then acquiring subsequent signals on the sideband channel.

An operation 706 decodes the sideband signal to recover the Scrambler ReSynch Message. Recall from above that the Scrambler ReSynch Message includes the LFSRs for both PTRS19 and PRBS11, which are the scrambling codes used to scramble the data used to create the high speed signal. In more detail, decoding the Scrambler ReSynch Message may proceed as follows. Assume that the information in the Scrambler ReSynch Message is for TX lane TX0. The Scrambler ReSynch Message contains 41 bits, which directly correspond to the 21 trits on the High speed TX0 lane. Next, the LFSR of the PRTS19 value for the TX0 lane may be produced by encoding bits 0 to 37 in byte 6 to 10, which is referred to below as SBD-1 (Sideband-1). Also, the LFSR of the PRBS11 value is carried in bytes 11 and 12, referred to below as SBD-2 (Sideband-2), and is also decoded. In some embodiments, the PRTS19 and PRBS11 scrambling codes may alternatively be retrieved from data acquired on the high speed data channels.

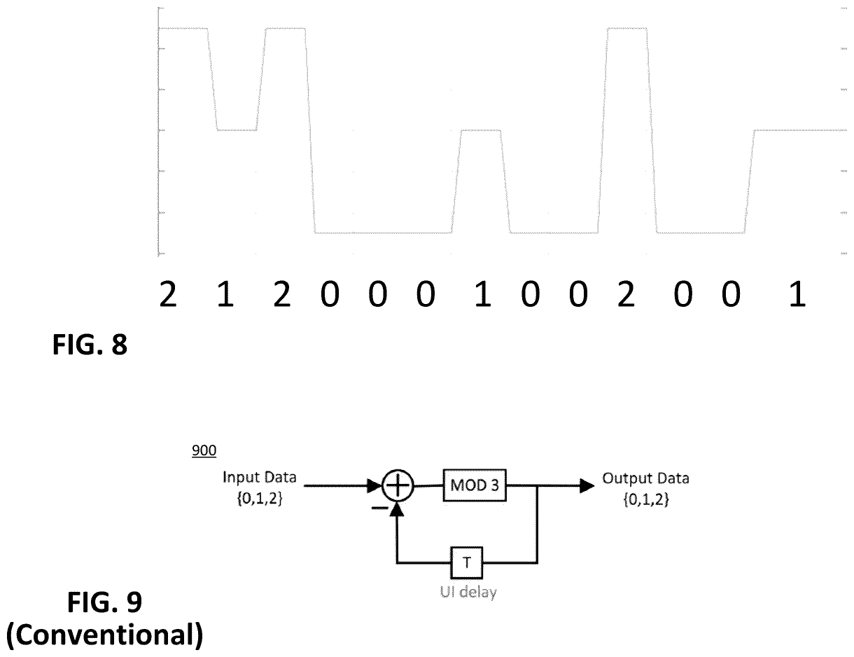

In an operation 708, the high-speed data signal acquired in the operation 702 is converted into trits. For example, as illustrated in FIG. 8 the 13 PAM-3 signals are converted into data, i.e., trits, that describe the state of each signal pulse.

Operation 710 removes the pre-coding information from the trits converted in operation 708. Removing the pre-coding may use the inverse process of that shown in FIG. 9, which is the conventional method for the USB4 v2.0 Specification to add pre-coding. The reverse operation can be given as:

$$Out [ n ] = MOD ( In [ n ] - Out [ n - 1 ) , 3 ) \qquad Eq . ( 1 )$$

After removing the precoding in IN_TX_Trits_Fstart_PC, the input data to the pre-coder is received. This stream is referred to as IN_TX_Trits_Fstart_(3).

Next, in an operation 712, the LFSR states for both PRBS11 and PRTS19 acquired on the data channel and the sideband channel are aligned, which aligns the data on the sideband channel with the data on the high speed channel.

In operation 714, an F stream is generated in a two-step process. The first step uses the PRTS19 acquired in operation 706. The F stream may have a sequence length up to 3\hat{ }19, but the number can be limited based on number of UIs in acquired in the signal. Then, after the first step in computing the F stream is completed, the second step in computing the F stream is finalized using the PRBS 11 value. As described above, the F operation in the ternary finite field keeps the PRTS19 ternary symbol unchanged if the corresponding PRBS11 bit is equal to 1b, and switches a ternary value of 2t with a ternary value of 0t, and vice-versa, if the corresponding PRBS11 bit is 0b. F_OUT_stream (2) is pre-generated with the initial value based on the TX lanes being decoded as set out above, with running values corresponding to PRTS19 and PRBS11 obtained from the sideband channel data.

Next, in an operation 716, the trits that had the pre-coding removed in operation 710 are descrambled. For example, IN_TX_Trits_Fstart are descrambled using the F_OUT_STREAM. In this example, the output is referred to as IN_TX_Descrambled_Trits.

The next challenge is to find the start of the FEC block to decode the payload acquired in the high speed signal because the incoming stream on the TX lane is continuous in nature and all are scrambled,

Since the data acquired by the oscilloscope 100 from the USB data lanes is free running in nature, and the user arbitrarily set the debug register to send the Resync information, the start of the RS-FEC block and the end of the RS-FEC block in the incoming trits stream (IN_TX_Trits_Fstart) is still unknown.

According to the USB4 v2.0 Standard, a USB4 port generates a time stamp whenever it either sends or receives a Time Sync Notification Ordered Set (TSNOS), referred to above with reference to FIG. 4. Also, according to the Standard, a downstream facing port sends a 24 trit TSNOS at the start of the next RS-FEC block after the time stamp point. An upstream facing port sends a 24 trit TSNOS at the start of the next RS-FEC block after receiving an indication to send the TSNOS. The TSNOS is transmitted based on the adapterTimeSyncInterval TSNOS timing interval, which as a maximum of 16 μsec and minimum of 1 μsec. Therefore, it is known that there will be one FEC block with TSNOS for every time sync interval, i.e., within every 16 μsecs.

As described above with reference to FIG. 4, according to USB4 v2.0, the TSNOS is an ordered set and its symbol value has value of 1110211t (FIG. 5). According to the ordered set communication, the TSNOS symbol is repeated for 3 control symbols, and this is also inserted in start of the FEC Block.

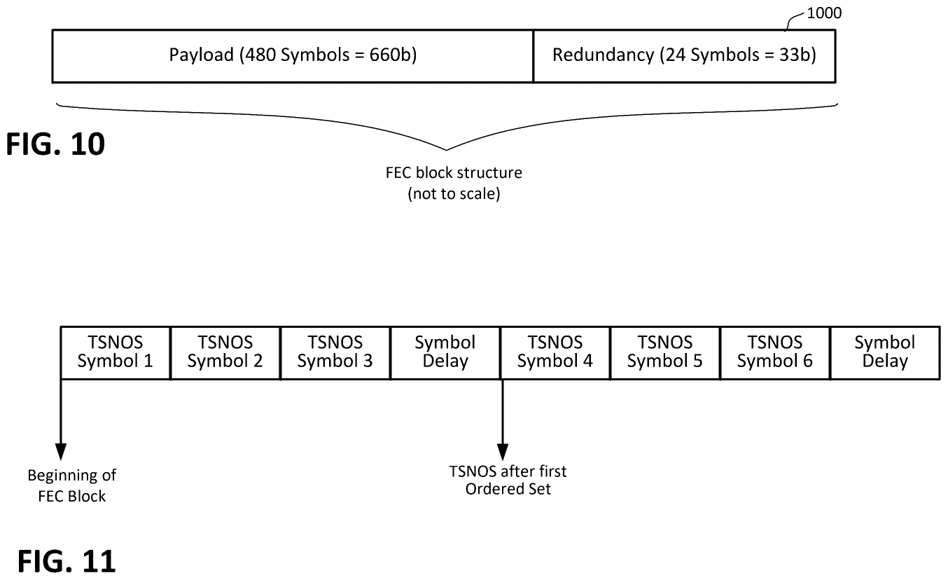

The structure of FEC block according to USB4 v2.0 is illustrated in FIG. 10. The FEC block 1000 has (480+24=504) symbols as payload, which means it may have a length up to 504*7 (up to 3528). Then the next FEC block begins in the data stream.

The ordered sets include a set of four repeating symbols. In the case of TSNOS, as illustrated in FIG. 11, three symbols initially repeat, and the fourth symbol indicates the delay value for the time synchronization. Recall from above that the TSNOS are placed in the FEC block. The FEC blocks are of fixed length, and the TSNOS begins at the start of the FEC block. Therefore, in the streaming data, the TSNOS symbol can appear only at multiples of the 3528 symbols from the start.

Once descrambled in the operation 716, an operation 718 searches the descrambled trits for the 21 trits of the TSNOS as “111021111102111110211t” in the descrambled stream (IN_TX_Descrambled_Trits), The first occurrence of this 21 trits is the Start of the FEC block. For example, assume that the data aligns at the kth trit, where k is always less than n, the number of trits being searched. Thus, IN_TX_Trits_Fstart_PC=IN_TX_Trits(k:n).

In more detail, to perform the searching operation 720, first demark the start of the FEC block in IN_TX_Descramble_Trits stream. Then isolate 3528 Trits from the demarcation spot, in both directions. This search is a brute-force method to locate the start of the FEC block within the acquired data stream, which may require performing calculations and matching on 7056 possible locations within the data stream (3528*2, i.e., 3528 in each direction from the demarcation location).

For example, assume that the incoming data trits in the acquired data stream, decoded from PAM-3 data are the following:
1 1 0 1 2 2 1 1 1 0 1 2 2 1 1 1

The Scrambled and pre coded value of the above data is:
2 1 0 0 1 0 1 1 1 0 2 1 0 1 2 2

After finding the F stream value, descrambling the above data, and after removing the precoding on the above data, the decoded data is:
1 1 0 1 2 2 1 1 1 0 1 2 2 1 1 1

Thus, it can be seen that, at one and exactly one of the possible 7056 locations isolated within the acquired data stream data, both the decoded data and incoming data match. When the incoming data matches the decoded data for the particular location, that particular location is the beginning of the FEC block for the incoming data.

In some embodiments, there is an option of having more than 4 channels on the oscilloscope at higher bandwidth (~25 GHZ) to decode the high speed signal on all four lanes. In such embodiments, the higher bandwidth oscilloscope can be synchronized with another, lower bandwidth oscilloscope, to acquire the sideband data. Thus, the combination of the low bandwidth oscilloscope sampling the sideband, and the higher bandwidth oscilloscope sampling the TX lanes, allows the system to adjust the trigger skew between the oscilloscope and its channels, then use the sideband channel information to decode the high speed link. Using the TSNOS to find the beginning of the FEC block on the high speed lane, by adjusting the F_OUT stream length that includes the delay, as described above, the high speed data lanes can be decoded.

One advantage of the systems described herein is that the user can continue to use the four channels even if only three high speed data lanes are decoded. Since all of the high speed data lanes are synchronized to send the data at the same time, finding the start of the FEC block on even one channel means that the FEC block is found for all channels.

Once the FEC block has been identified, large portions of the high speed data can be properly de-scrambled, converted back to binary signals, then sent to another system for further evaluation. For example, the decoded data may be sent to a protocol analyzer or protocol decoder for further analysis. In some embodiments, any of the data acquired by the oscilloscope, or the decoded data, or the binary data may be displayed on the UI 110 (FIG. 1) or stored for later retrieval and analysis.

Aspects of the disclosure may operate on a particularly created hardware, on firmware, digital signal processors, or on a specially programmed general-purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, Field-Programmable Gate Arrays (FPGAs), and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include Random Access Memory (RAM), Read Only Memory (ROM), Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The foregoing description has been set merely to illustrate the invention and is not intended to be limited. Since modifications of the disclosed embodiments incorporating the substance of the invention may occur to person skilled in the art, the invention should be construed to include everything within the scope of the invention.

### EXAMPLES

Illustrative examples of the disclosed technologies are provided below. An embodiment of the technologies may include one or more, and any combination of, the examples described below.

Example 1 is a test and measurement device including a first input coupled to a sideband data communication channel that carries data related to one or more high speed data channels between a host and a device, the first input structured to acquire data carried on the sideband data communication channel, a second input coupled to one of the one or more high speed data channels and structured to acquire data signals carried on the coupled high speed data channel and one or more processors structured to send a command to provoke the host to send a retiming message that includes one or more scrambling codes that were used to encode data signals on the coupled high speed data channel, extract the one or more scrambling codes from the retiming message, convert the data signals received on the coupled high speed data channel to coded data, descramble the coded data using the one or more scrambling codes extracted from the retiming message into descrambled data, and search the descrambled data for a predetermined code sequence.

Example 2 is a test and measurement device according to Example 1, wherein the one or more processors are further structured to, after the data received on the coupled high speed data is converted to coded data, remove precoding data from the coded data.

Example 3 is a test and measurement device according to any preceding Example, wherein the one or more processors are further structured to align data carried on the sideband data communication channel to data carried on the high speed data channel, and decode the data carried on the sideband data communication channel and the data carried on the high speed data channel.

Example 4 is a test and measurement device according to any preceding Example, in which the host and the device communicate using a USB4 v2.0 protocol.

Example 5 is a test and measurement device according to any preceding Example, in which the sideband data communication channel carries binary data, and in which the one or more high speed data channels carry ternary data.

Example 6 is a test and measurement device according to Example 5 in which the ternary data is coded using Pulse Amplitude Modulation, 3 level.

Example 7 is a test and measurement device according to Examples 5 or 6, in which the coded data is ternary data, and in which the one or more processors are structured to convert the ternary data to binary data.

Example 8 is a test and measurement device according to Example 7, in which the one or more processors are further configured to send the binary data out of the test and measurement device to another device.

Example 9 is a test and measurement device according to Example 7, in which the one or more processors are further configured to store the binary data within the test and measurement device.

Example 10 is a test and measurement device according to any of preceding Examples 7-9, further comprising a display, and in which the one or more processors are further configured to output either or both of the ternary data and the binary data on the display in addition to the data signals acquired from the high speed data channel.

Example 11 is a computer-implemented method, including acquiring sideband data from a sideband data communication channel that carries data related to one or more high speed data channels between a host and a device, acquiring high speed data signals from one of the one or more high speed data channels, sending a command to provoke the host to send a retiming message that includes one or more scrambling codes that were used to encode the data signals on the coupled high speed data channel, extracting the one or more scrambling codes from the retiming message, converting the data signals received on the related high speed data channel to coded data, descrambling the coded data using the one or more scrambling codes extracted from the retiming message, and searching the descrambled data for a predetermined code sequence.

Example 12 is a method according to Example 11, further comprising, after converting the data signals received on the related high speed data channel to coded data, removing precoding data from the coded data.

Example 13 is a method according to Examples 11 or 12, further comprising aligning data carried on the sideband data communication channel to data carried on the high speed data channel.

Example 14 is a method according to any preceding Example method, in which the host and the device communicate using a USB4 v2.0 protocol.

Example 15 is a method according to any preceding Example method, in which the sideband data channel carries binary data, and in which the one or more high speed data channels carry ternary data.

Example 16 is a method according to Example 15 in which the ternary data is coded using Pulse Amplitude Modulation, 3 level.

Example 17 is a method according to any preceding Example method, in which converting the data signals received on the related high speed data channel to coded data comprises converting the data signals to ternary data, and further comprising converting the ternary data to binary data.

Example 18 is a method according to Example 17, in which acquiring high speed data signals from one of the one or more high speed data channels is performed by a test and measurement device, and further comprising sending the binary data out of the test and measurement device to another device.

Example 19 is a method according to Example 18, further comprising storing the binary data within the test and measurement device.

Example 20 is a method according to Example 18 or Example 19, further comprising showing either or both of the ternary data and binary data on a display in addition to the data signals acquired from the one or more high speed data channels.

This written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

What is claimed is:

1. A test and measurement device, comprising:
a first input coupled to a sideband data communication channel that carries data related to one or more high speed data channels between a host and a device, the first input structured to acquire data carried on the sideband data communication channel;
a second input coupled to one of the one or more high speed data channels and structured to acquire data signals carried on the coupled high speed data channel; and
one or more processors structured to:
send a command to provoke the host to send a retiming message that includes one or more scrambling codes that were used to encode data signals on the coupled high speed data channel,
extract the one or more scrambling codes from the retiming message,
convert the data signals received on the coupled high speed data channel to coded data,
descramble the coded data using the one or more scrambling codes extracted from the retiming message into descrambled data, and
search the descrambled data for a predetermined code sequence.

2. The test and measurement device according to claim 1, wherein the one or more processors are further structured to, after the data received on the coupled high speed data is converted to coded data, remove precoding data from the coded data.

3. The test and measurement device according to claim 2, wherein the one or more processors are further structured to:
align data carried on the sideband data communication channel to data carried on the high speed data channel, and
decode the data carried on the sideband data communication channel and the data carried on the high speed data channel.

4. The test and measurement device according to claim 1, in which the host and the device communicate using a USB4 v2.0 protocol.

5. The test and measurement device according to claim 1, in which the sideband data communication channel carries binary data, and in which the one or more high speed data channels carry ternary data.

6. The test and measurement device according to claim 5 in which the ternary data is coded using Pulse Amplitude Modulation, 3 level.

7. The test and measurement device according to claim 1, in which the coded data is ternary data, and in which the one or more processors are structured to convert the ternary data to binary data.

8. The test and measurement device according to claim 7, in which the one or more processors are further configured to send the binary data out of the test and measurement device to another device.

9. The test and measurement device according to claim 8, in which the one or more processors are further configured to store the binary data within the test and measurement device.

10. The test and measurement device according to claim 8, further comprising a display, and in which the one or more processors are further configured to output either or both of the ternary data and the binary data on the display in addition to the data signals acquired from the high speed data channel.

11. A computer-implemented method, comprising:
acquiring sideband data from a sideband data communication channel that carries data related to one or more high speed data channels between a host and a device;
acquiring high speed data signals from one of the one or more high speed data channels;
sending a command to provoke the host to send a retiming message that includes one or more scrambling codes that were used to encode the data signals on the coupled high speed data channel;
extracting the one or more scrambling codes from the retiming message;
converting the data signals received on the related high speed data channel to coded data;
descrambling the coded data using the one or more scrambling codes extracted from the retiming message; and
searching the descrambled data for a predetermined code sequence.

12. The method according to claim 11, further comprising, after converting the data signals received on the related high speed data channel to coded data, removing precoding data from the coded data.

13. The method according to claim 12, further comprising aligning data carried on the sideband data communication channel to data carried on the high speed data channel.

14. The method according to claim 11, in which the host and the device communicate using a USB4 v2.0 protocol.

15. The method according to claim 11, in which the sideband data channel carries binary data, and in which the one or more high speed data channels carry ternary data.

16. The method according to claim 15 in which the ternary data is coded using Pulse Amplitude Modulation, 3 level.

17. The method according to claim 11, in which converting the data signals received on the related high speed data channel to coded data comprises converting the data signals to ternary data, and further comprising converting the ternary data to binary data.

18. The method according to claim 17, in which acquiring high speed data signals from one of the one or more high speed data channels is performed by a test and measurement device, and further comprising sending the binary data out of the test and measurement device to another device.

19. The method according to claim 18, further comprising storing the binary data within the test and measurement device.

20. The method according to claim 18, further comprising showing either or both of the ternary data and binary data on a display in addition to the data signals acquired from the one or more high speed data channels.
